(19) United States
(12) Patent Application Publication
(10) Pub. No.: US 2026/0067589 A1
(43) Pub. Date: Mar. 5, 2026

(54) IMAGE CAPTURING APPARATUS AND CONTROL METHOD THEREOF, AND STORAGE MEDIUM

(71) Applicant: CANON KABUSHIKI KAISHA, Tokyo (JP)

(72) Inventor: YUKO SATO, Kanagawa (JP)

(21) Appl. No.: 19/288,536

(22) Filed: Aug. 1, 2025

(30) Foreign Application Priority Data
Aug. 29, 2024 (JP) 2024-147843

(51) Int. Cl. H04N 25/50; H04N 25/76; H04N 25/77; H04N 25/78

(52) U.S. Cl. CPC H04N 25/50; H04N 25/77; H04N 25/7795; H04N 25/78

(57) ABSTRACT

An image capturing apparatus comprises: a plurality of pixels each including a sensor that outputs pulses at a frequency corresponding to a frequency of receiving a photon, and a counter that counts the number of the pulses; a control unit that controls a timing for resetting count values and a timing for reading out the count values; and a generation unit that generates a first signal at a predetermined first frame rate based on the count values read out at a plurality of different timings and the timings at which the count values are read out, and generates a second signal at a second frame rate corresponding to an exposure period longer than each frame period of the first frame rate. Upon resetting the count values, the control unit controls to read out the count values and then reset the count values.

### BACKGROUND

### Field of the Technology

The present disclosure relates to an image capturing apparatus and control method thereof, and a storage medium and more specifically to a technique for capturing a moving image and performing a continuous shooting of still images in parallel by an image capturing apparatus.

### Description of the Related Art

Conventionally, when performing continuous shooting of still images, image capturing apparatuses have been required to assist photographers in framing by recording and displaying moving images at a frame rate higher than that of the continuous shooting between shootings of still images in the continuous shooting.

For example, Japanese Patent Laid-Open No. 2022-131605 discloses a technique for capturing still images in a spare time between an accumulation period and a readout period while capturing a moving image for live view (LV) display.

However, in the conventional technology disclosed in Japanese Patent Laid-Open No. 2022-131605, since continuous shooting of still images is performed in a spare time of shooting a moving image for display, there is a restriction on the charge accumulation period for the still images. On the other hand, if the charge accumulation period of the still images is secured beyond the restriction, the frame rate of the LV display drops, and the frame rate of the continuous shooting of the still images also drops.

### SUMMARY

The present disclosure has been made in consideration of the above problems, and makes it possible to simultaneously obtain a high frame rate moving image for recording or moving image for display while maintaining the continuous shooting rate upon continuously shooting still images.

According to the present disclosure, provided is an image capturing apparatus comprising: a plurality of pixels, each of which includes a sensor that outputs pulses at a frequency corresponding to a frequency of receiving a photon, and a counter that counts the number of the pulses; and one or more processors and/or circuitry which function as: a control unit that controls a timing for resetting count values counted by the counters and a timing for reading out the count values; and a generation unit that generates a first signal at a predetermined first frame rate based on the count values read out at a plurality of different timings and the timings at which the count values are read out, and generates a second signal at a second frame rate corresponding to an exposure period longer than each frame period of the first frame rate, wherein in a case of resetting the count values, the control unit performs control so as to read out the count values and then reset the count values.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example configuration of an image sensor according to an embodiment of the present disclosure.

FIG. 2 is a diagram illustrating an example configuration of a sensor substrate according to the embodiment.

FIG. 3 is a diagram illustrating an example configuration of a circuit substrate according to the embodiment.

FIG. 4 is a block diagram illustrating a schematic configuration of a photoelectric conversion unit and a signal processing circuit according to a first embodiment.

FIG. 5 is a diagram illustrating a schematic diagram of relationship between an operation of the photoelectric conversion unit and an output signal.

FIG. 6 is a block diagram illustrating a general configuration of an image capturing apparatus according to an embodiment.

FIG. 7 is a timing diagram for explaining control of the image sensor according to the first embodiment.

FIG. 8 is a flowchart illustrating an actuation method of the image sensor according to the first embodiment.

FIG. 9 is a flowchart illustrating the actuation method of the image sensor according to the first embodiment.

FIG. 10 is a flowchart of moving image calculation processing according to the first embodiment.

FIG. 11 is a timing diagram illustrating an issue with an exposure period according to a modification of the first embodiment.

FIG. 12 is a timing diagram illustrating a start timing of an exposure period and a signal readout timing according to the modification of the first embodiment.

FIG. 13 is a block diagram illustrating a schematic configuration of a photoelectric conversion unit and a signal processing circuit according to the modification of the first embodiment.

FIG. 14 is a timing diagram for explaining control of the image sensor according to a second embodiment.

FIG. 15 is a timing diagram for explaining control of the image sensor according to a modification of the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

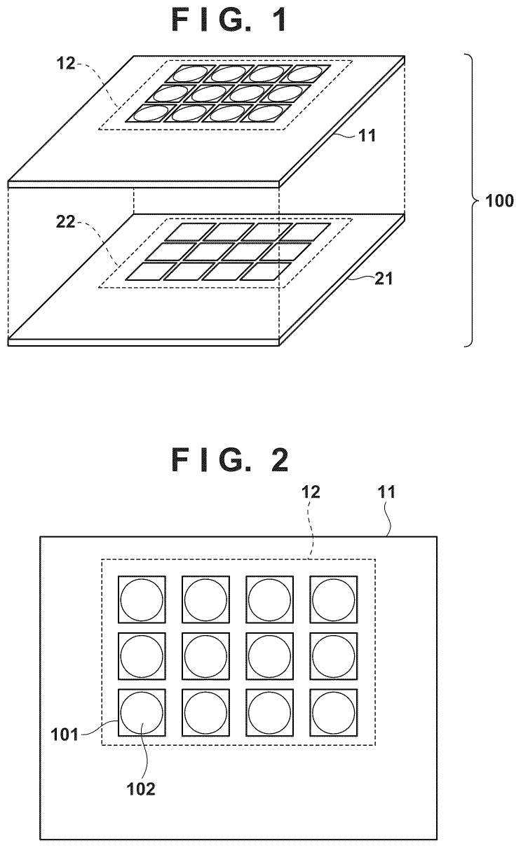

FIG. 1 is a diagram showing an example of the configuration of an image sensor 100 in the first embodiment. In this embodiment, the image sensor 100 has a so-called stacked structure in which two semiconductor substrates, a sensor substrate 11 and a circuit substrate 21, are stacked and electrically connected. However, the image sensor 100 may have a so-called non-stacked structure in which the configuration included in the sensor substrate and the configuration included in the circuit substrate are arranged on the same semiconductor layer. The sensor substrate 11 includes a photoelectric conversion region 12, and the circuit substrate 21 includes a signal processing region 22 that processes signals acquired in the photoelectric conversion region 12.

FIG. 2 is a diagram showing an example of pixel arrangement in the sensor substrate 11. The photoelectric conversion region 12 of the sensor substrate 11 includes a plurality of photoelectric conversion units 102 included in a plurality of pixels 101 arranged two-dimensionally in a plurality of rows and a plurality of columns. The photoelectric conversion units 102 are configured with avalanche photodiodes (APDs). A voltage which drops at a frequency corresponding to the frequency of receiving photons is output from the photoelectric conversion units 102. It should be noted that the number of pixels included in the photoelectric conversion region 12 and the number of rows and columns of pixels are not particularly limited.

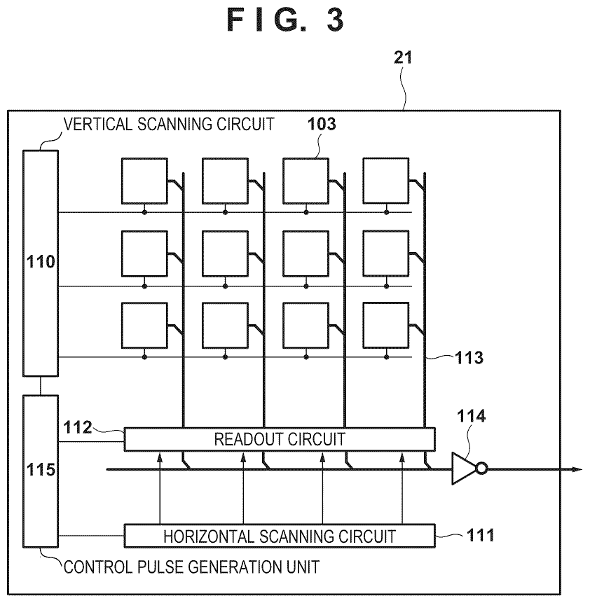

FIG. 3 is a diagram showing an example of the arrangement of each circuit in the circuit substrate 21. The circuit substrate 21 has signal processing circuits 103 each of which processes the voltage output from each photoelectric conversion unit 102 shown in FIG. 2, a readout circuit 112, a control pulse generation unit 115, a horizontal scanning circuit 111, vertical signal lines 113, a vertical scanning circuit 110, and an output circuit 114. Each pixel 101 includes a photoelectric conversion unit 102 and a signal processing circuit 103.

The vertical scanning circuit 110 receives control pulses supplied from a control pulse generation unit 115, and sequentially supplies control pulses to the plurality of signal processing circuits 103 arranged in the row direction. Logic circuits such as a shift register and an address decoder are used in the vertical scanning circuit 110.

In each pixel 101, the voltage output from the photoelectric conversion unit 102 is processed by each signal processing circuit 103. The signal processing circuit 103 includes a counter for counting the number of signal pulses that are resulted from voltage drops of the voltage output from the photoelectric conversion unit 102, and signals (count values) are output from the signal processing circuits 103 of the row selected by the vertical scanning circuit 110 to the vertical signal lines 113. The readout circuit 112 has a plurality of buffers each connected to each vertical signal line 113 and holds the signal output to each vertical signal line 113. The horizontal scanning circuit 111 inputs control pulses that sequentially select the columns to the readout circuit 112, and the signals held in the plurality of buffers of the horizontal scanning circuit 111 are output to the outside of the image sensor 100 via the output circuit 114.

By repeating the above-mentioned row selection by the vertical scanning circuit 110 and column selection by the horizontal scanning circuit 111, the signal for all pixels processed by the signal processing circuit 103 can be output.

Further, as shown in FIGS. 2 and 3, the plurality of signal processing circuits 103 are arranged in a region overlapping the photoelectric conversion region 12 in a planar view. The vertical scanning circuit 110, the horizontal scanning circuit 111, the readout circuit 112, the output circuit 114, and the control pulse generation unit 115 are arranged so as to overlap in a region between an end of the sensor substrate 11 and an end of the photoelectric conversion region 12 in a planar view. In other words, the sensor substrate 11 has the photoelectric conversion region 12 and a non-photoelectric conversion region arranged around the photoelectric conversion region 12. The vertical scanning circuit 110, the horizontal scanning circuit 111, the readout circuit 112, the output circuit 114, and the control pulse generation unit 115 are arranged in a region of the circuit substrate 21 overlapping the non-photoelectric conversion region in a planar view.

The arrangement of the vertical signal lines 113, the readout circuit 112, and the output circuit 114 are not limited to the example shown in FIG. 3. For example, the vertical signal lines 113 may be arranged extending in the row direction, and the readout circuit 112 may be arranged at the end of the vertical signal lines 113. Also, the signal processing circuit 103 does not necessarily need to be provided for each photoelectric conversion unit 102, and one signal processing unit may be shared by a plurality of photoelectric conversion units 102 and perform signal processing sequentially.

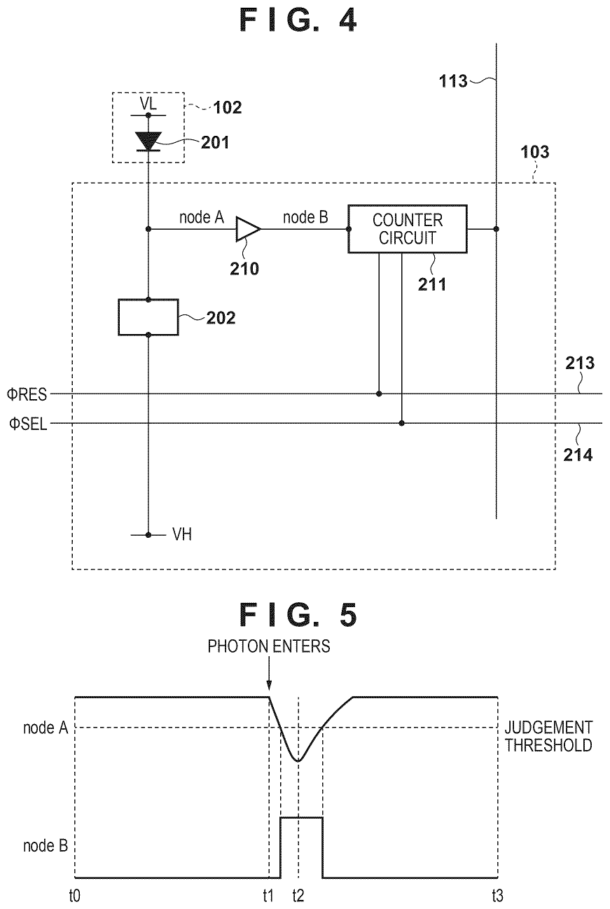

FIG. 4 is a block diagram illustrating the configuration of one photoelectric conversion unit 102 and one signal processing circuit 103 corresponding to the photoelectric conversion unit 102 shown in FIGS. 2 and 3.

An APD 201 included in the photoelectric conversion unit 102 generates charges according to incident light by photoelectric conversion. One of the two nodes of the APD 201 is connected to a power supply line to which an actuation voltage VL is supplied. The other of the two nodes of the APD 201 is connected to a power supply line to which an actuation voltage VH higher than the voltage VL is supplied.

In FIG. 4, one node of the APD 201 is an anode, and the other node of the APD 201 is a cathode. A reverse bias voltage is applied between the anode and cathode of the APD 201 so that avalanche multiplication occurs in the APD 201. By applying such a voltage across the APD 201, the charge generated by the incident light causes avalanche multiplication, generating an avalanche current.

In a case where a reverse bias voltage is applied, there are two modes that the APD 201 can be operated: Geiger mode, in which the voltage applied between the anode and cathode is greater than the breakdown voltage, and linear mode, in which the voltage applied between the anode and cathode is close to or less than the breakdown voltage. APDs operated in Geiger mode are called SPADs (single photon avalanche diodes). In the case of a SPAD, for example, the actuation voltage VL is −30V and the actuation voltage VH is 1V.

The signal processing circuit 103 includes a quench element 202, a waveform shaping unit 210, and a counter circuit 211. The quench element 202 is connected to a power supply line through which the actuation voltage VH is supplied and to one of the anode and cathode of the APD 201.

The quench element 202 functions as a load circuit (quench circuit) during signal multiplication by avalanche multiplication, suppressing the voltage applied to the APD 201 to suppress avalanche multiplication (quenching operation). The quench element 202 also functions to return the voltage applied across the APD 201 to the actuation voltage VH by providing a current equivalent to the voltage drop by the quenching operation (recharging operation).

The waveform shaping unit 210 shapes the voltage change at the cathode of the APD 201 obtained when a photon is detected, and outputs a pulse signal. For example, an inverter circuit is used as the waveform shaping unit 210. Note that, although an example using one inverter as the waveform shaping unit 210 is shown in FIG. 4, a circuit in which a plurality of inverters are connected in series may be used, or other circuits having a waveform shaping function may be used.

The counter circuit 211 counts the number of signal pulses output from the waveform shaping unit 210 and holds the count value. When a control pulse φRES is supplied via an actuation line 213, the signal held in the counter circuit 211 is reset. When a control pulse φSEL is supplied via an actuation line 214 and the counter circuit 211 and the vertical signal line 113 whose electrical connection can be switched between connection/disconnection is connected, the signal (count value) held by the counter circuit 211 of each pixel 101 is output to the vertical signal line 113.

Note that electrical connection may be switched by disposing a switch such as a transistor between the quench element 202 and the APD 201 or between the photoelectric conversion unit 102 and the signal processing circuit 103. Similarly, the actuation voltage VH or the actuation voltage VL applied to the photoelectric conversion unit 102 may be electrically switched using a switch such as a transistor.

FIG. 5 is a diagram illustrating a schematic relationship between the operation of the APD 201 and the output signal, with the input side of the waveform shaping unit 210 being a node A and the output side a node B. Between time t0 and time t1, there is a potential difference of the actuation voltage VH—the actuation voltage VL across the APD 201. When a photon is incident on the APD 201 at time t1, avalanche multiplication occurs in the APD 201, an avalanche multiplication current flows in the quench element 202, and the voltage of the node A drops.

When an amount of the voltage drop increases and the potential difference across the APD 201 becomes small, the avalanche multiplication of the APD 201 stops at time t2, and the voltage level of the node A does not drop below a certain value. After that, between time t2 and time t3, a current that compensates for the voltage drop flows in the node A from the voltage VL side, and at time t3, the node A is stabilized to the original potential level. At this time, the output waveform of the node A is shaped by the waveform shaping unit 210 for a portion that exceeds a predetermined judgment threshold and for a portion that does not exceed the threshold, and is output to the node B as a pulse signal.

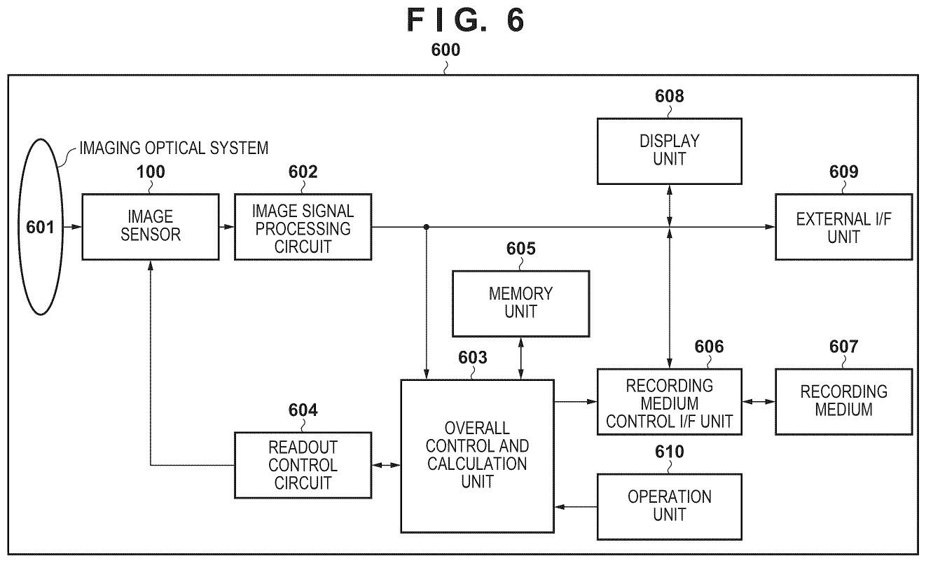

Next, the configuration of an image capturing apparatus 600 will be described as an example of an apparatus using the image sensor 100 described above. FIG. 6 is a block diagram illustrating the configuration of the image capturing apparatus 600 according to the first embodiment. The image capturing apparatus in the present disclosure includes any electronic device capable of having an image capturing function. Such electronic devices include video cameras, digital cameras, computer devices (personal computers, tablet computers, media players, PDAs, etc.), mobile phones, smartphones, game consoles, robots, drones, dashboard cameras, wearable scopes, etc. These are merely examples, and the present disclosure can be applied to other electronic devices. The present disclosure can also be applied to a configuration in which the subject detection function and the image capturing function are provided in separate devices (for example, a main body and a remote controller) that can communicate with each other.

The image capturing apparatus 600 has the image sensor 100 described with reference to FIGS. 1 to 5, an imaging optical system 601, an image signal processing circuit 602, an overall control and calculation unit 603, a readout control circuit 604, a memory unit 605, a recording medium control interface (I/F) unit 606, a recording medium 607, a display unit 608, an external interface (I/F) unit 609, and an operation unit 610.

The image signal processing circuit 602 performs various image signal processing such as low-pass filter processing for reducing noise, shading correction processing, and WB correction processing on the signal (count values) input from the image sensor 100. It also performs various corrections such as defective pixel correction, dark shading correction, and dark current removal, compression, and the like to generate image data.

The overall control and calculation unit 603 controls the entire image capturing apparatus 600 and performs various calculations. The readout control circuit 604 generates actuation pulses for actuating the image sensor 100 based on a control signal from the overall control and calculation unit 603.

The memory unit 605 temporarily stores image data generated by the image signal processing circuit 602. The recording medium control I/F unit 606 records and reads image data on/from the recording medium 607. The recording medium 607 is a removable storage medium such as a semiconductor memory, and stores image data. The display unit 608 displays the image data. The external I/F unit 609 is an interface for communicating with an external computer or the like.

The operation unit 610 is used to input various instructions from the user to the image capturing apparatus 600, and is composed of various operation members such as buttons, dials, switches, a touch panel, a gaze detection device, and a voice detection device. Information on the operating conditions of the image capturing apparatus 600 set by the user by operating the operation unit 610 is sent to the overall control and calculation unit 603, and the image capturing apparatus 600 is controlled overall based on this information. The operation unit 610 includes a power button, a still image recording button, and a moving image recording button (not shown), and the image capturing apparatus 600 can be turned on/off by turning the power button on/off. In addition, when the image capturing apparatus 600 is on, by turning on the still image recording button, the start of still image recording can be instructed, and by turning on the moving image recording button, the start of moving image recording can be instructed. It is also possible to use the same operation member as the still image recording button and the moving image recording button.

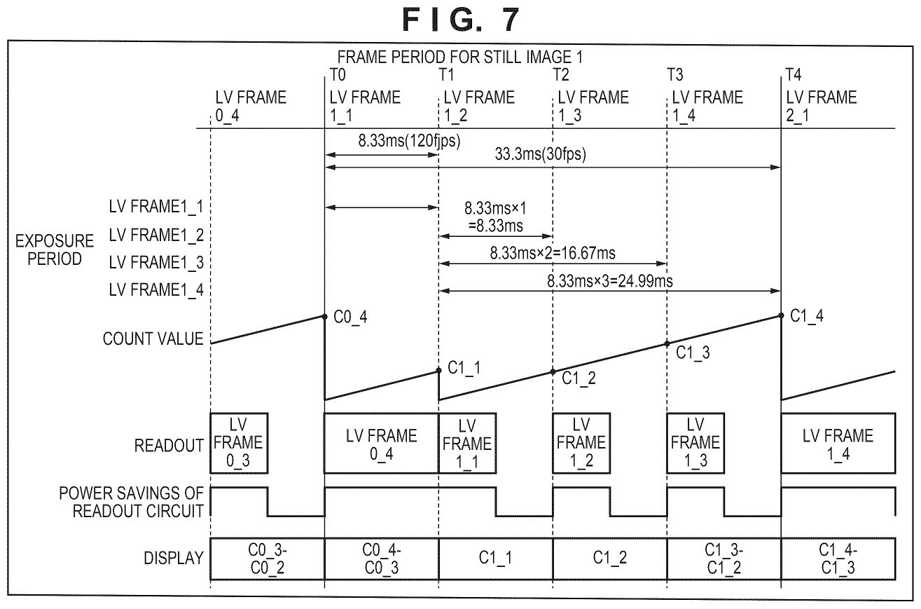

FIG. 7 is a timing diagram for explaining the control method of the image sensor 100 controlled by the overall control and calculation unit 603 according to this embodiment. As an example, the control will be explained here in a case where the operation unit 610 instructs continuous shooting of still images at 30 fps while a moving image for live view (LV) display (hereinafter, referred to as “LV image”) is being captured at 120 fps. At this time, the exposure period (counting period) of the still images is set to be an integer multiple of one frame period of the LV image, and the count start timing of the counter circuit 211 and the readout timing of the count value are controlled to match the frame rate of the LV image. In this embodiment, one still image is captured with three frame periods of the LV image as the exposure period (25 ms) of the still image. That is, as shown in FIG. 7, one frame period of the still image (T0 to T4) is equally divided to make one frame period of the LV image, and in this case, one frame period of the LV image is 8.33 ms (≈33.3 ms/4).

In addition, in FIG. 7, the frame period of an LV image is represented as LV frame i_j, where i (≥0) represents the still image number, and j (=1 to 4) represents the frame numbers of the LV image in one frame period of the still image.

Note that the LV image and the still image do not necessarily need to have the same number of pixels, and for example, the LV image may be thinned out and read out at a predetermined rate (for example, every third pixel) in both the horizontal and vertical directions. In this case, the signal read out in the LV frame i_4 represents both a moving image for display and a still image, and may be read out according to the purpose, for example, by first reading out the signal of every third pixel for the LV image, and then reading out the signal of all pixels for the still image after the reading out of the LV image is completed.

Furthermore, the readout control circuit 604 may have a power saving function for turning off the power supply to the readout circuit during a period when readout is not being performed. This corresponds to the readout circuit power saving period shown in FIG. 7.

In FIG. 7, the exposure period indicates the exposure period corresponding to LV frames 1_1 to 1_4 in a frame period of a still image 1. The LV frame 1_1 has an exposure period starting from start time TO of a frame of the still image 1 and ending at end time T1 of the LV frame 1_1. the LV frame 1_2 has an exposure period from time T1 to time T2, the LV frame 1_3 has an exposure period from time T1 to time T3, and the LV frame 1_4 has an exposure period from time T1 to time T4. That is, the counter circuit 211 is reset at times TO and T1, and count values C1_1, C1_2, C1_3, and C1_4 are read out from counter circuit 211 at times T1 to T4, respectively.

Then, the signal obtained by performing counting during the period of the LV frame 1_1 is read out between times T1 and T2, and are promptly processed by the image signal processing circuit 602. Similarly, the signals obtained by performing counting during the periods of the LV frame 1_2, the LV frame 1_3, and the LV frame 1_4 are sequentially read out between times T2 and T3, between times T3 and T4, and between times T4 and T5 (not shown), respectively, and are promptly processed by the image signal processing circuit 602.

The overall control and calculation unit 603 performs control so as to take a difference between signals whose exposure periods of the LV image overlap in order to keep the exposure periods of frames of the LV image constant, and to display the obtained signal on the display unit 608. For example, the count value C1_3 corresponds to exposure periods of two frame periods of the LV frames 1_2 and 1_3, and the count value of the exposure period corresponding to the LV frame 1_3 can be obtained by taking the difference between the count value C1_3 and the count value C1_2 corresponding to the LV frame 1_2. The count value C1_4 corresponds to exposure periods of three frame periods of the LV frames 1_2, 1_3, and 1_4, and the count value of the exposure period corresponding to the LV frame 1_4 can be obtained by taking the difference between the count value C1_4 and the count value C1_3. At this time, the overall control and calculation unit 603 performs image processing so that the luminance of the LV image between frames is constant.

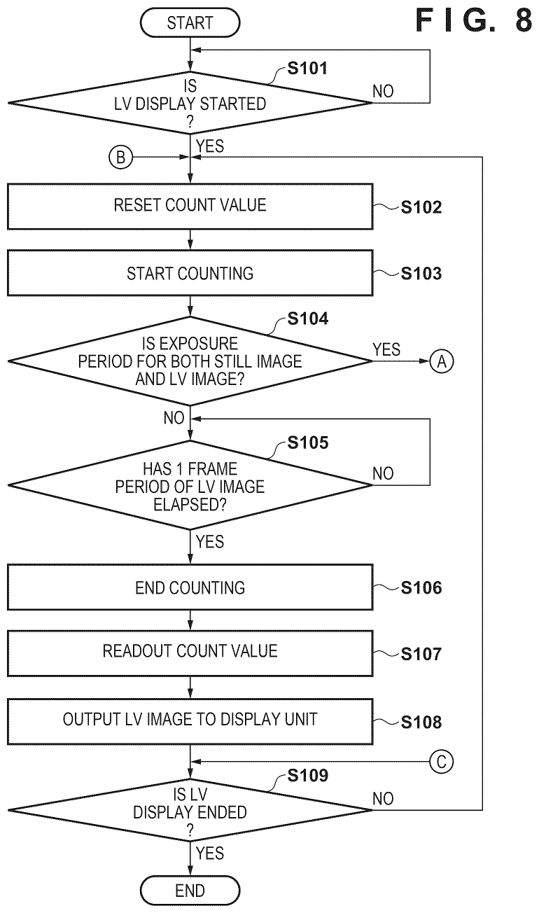

FIGS. 8, 9, and 10 are flowcharts showing details of a method for actuating the image sensor 100 in this embodiment. Note that the operations of the steps shown in the flowcharts of FIGS. 8, 9, and 10 are performed by a CPU or the like serving as a computer in the overall control and calculation unit 603 executing a computer program stored in a memory.

First, in step S101 in FIG. 8, it is determined whether or not to start LV display on the display unit 608. The determination in step S101 is repeated until LV display is started (No in step S101). When LV display is started (Yes in step S101), the process proceeds to step S102, where count values of the counter circuits 211 are reset by the control pulse (bRES. This operation corresponds to the reset operation of the counter circuits 211 at time TO or time T1 in FIG. 7. As a result, counting by the counter circuits 211 is started in step S103.

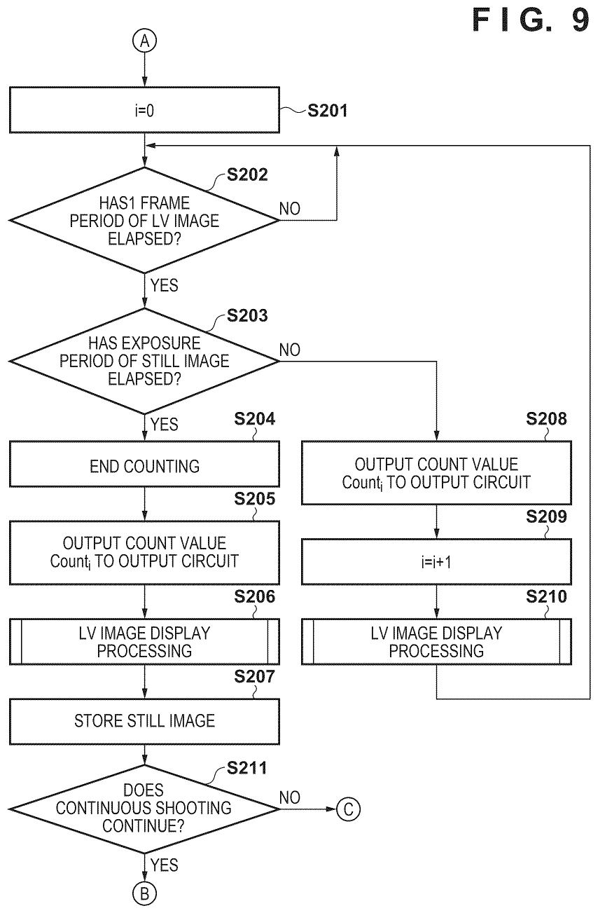

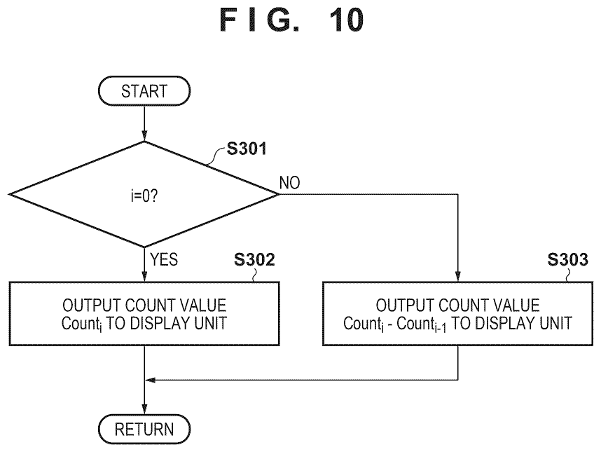

Next, in step S104, it is determined whether the current counting operation, i.e., the exposure period of the image sensor 100, is for both the still image and the LV image. If it is determined that the exposure period is for both the still image and the LV image (Yes in step S104), the process proceeds to the processing of the flowchart in FIG. 9. If it is determined that the exposure period is not for both the still image and the LV image (No in step S104), it is determined in the following step S105 whether a predetermined period (one frame period of the LV image) has elapsed since the counting by the counter circuits 211 was started in step S103. If one frame period of the LV image has not elapsed (No in step S105), the process returns to step S105. If it is determined that one frame period of the LV image has elapsed (Yes in step S105), the counting by the counter circuits 211 is ended in the following step S106, the count values are read out in step S107, and an LV image based on the count values is output to the display unit 608 in step S108.

In step S109, it is determined whether or not to end the LV display. If it is determined that the LV display is to be continued (No in step S109), the process returns to step S102, and if it is determined that the LV display is to be ended (Yes in step S109), this processing ends.

Next, with reference to FIG. 9, an operation to be performed in a case where it is determined in step S104 that the current counting operation is for both a still image and an LV image will be described.

First, in step S201, the variable i is set to 0. In the following step S202, it is determined whether or not one frame period of the LV image has elapsed since the counting by the counter circuits 211 was started in step S103. If one frame period of the LV image has not elapsed (No in step S202), the process returns to step S202. If it is determined that one frame period of the LV image has elapsed (Yes in step S202), it is determined in the following step S203 whether or not the exposure period of the still image has elapsed.

If it is determined that the exposure period of the still image has not elapsed, the process proceeds to step S208, where the count values Countᵢ are read out from the counter circuits 211 and output to the image signal processing circuit 602 from the output circuit 114. Thereafter, in step S209, the variable i is incremented by 1, and the process proceeds to step S210. In step S210, a process of displaying the LV image is performed using the read count values Countᵢ, and the process performed here will be described later with reference to FIG. 10. Note that the order of the process of step S209 and the process of step S210 may be reversed, or they may be performed in parallel.

After step S210, the process returns to step S202. At this time, in step S202, it is determined whether or not one frame period of the LV image has elapsed since it was determined in the previous step S202 that one frame period of the LV image had elapsed, not since the counting by the counter circuits 211 was started in step S103. Thereafter, the above-mentioned processes are repeated.

On the other hand, if it is determined in step S203 that the exposure period of the still image has elapsed (Yes in step S203), the counting by the counter circuits 211 is ended in step S204, and the count values Countᵢ are read out from the counter circuits 211 in step S205 and output to the image signal processing circuit 602 from the output circuit 114. The count values Countᵢ read out here are used in the next process of displaying the LV image in step S206, and are also processed by the image signal processing circuit 602 in step S207 and stored in the memory unit 605 as an image signal of the still image. The process performed in step S206 will be described with reference to FIG. 10.

After step S207, in step S211, it is determined whether another still image is to be continuously shot (continue continuous shooting) or not. For example, in this case, if the continuous shooting mode is set by the operation unit 610 and the still image recording button is pressed, it is determined that another still image is to be continuously shot. If another still image is to be continuously shot, the process returns to step S102 in FIG. 8, and if not, the process proceeds to step S109 in FIG. 8.

Next, the LV image display process performed in step S206 or step S210 in FIG. 9 will be described with reference to FIG. 10. This process is performed in a case where a signal for an LV image is acquired during the exposure period of a still image. As described in FIG. 7, for count values corresponding to periods when the exposure period of the LV image and the exposure period of the still image overlap, it is necessary to calculate the difference between the readout count values.

In step S301, it is determined whether or not the variable i is 0. If the variable i is 0 (Yes in step S301), in step S302, an image is output to the display unit 608 based on the count values Countᵢ. If the variable i is not 0 (No in step S301), in step S303, the difference between the count values Countᵢ and the count values Countᵢ₋₁ of the previous LV frame (the count values read out one frame period before) are output to the display unit 608. This makes it possible to remove the count values corresponding to overlapping exposure period and display an image based on the count values corresponding to each frame period of the LV image.

When the process of step S302 or S303 is completed, the process returns to step S206 or S210 in FIG. 9.

As described above, according to the first embodiment, by reading out an image for LV display during exposure of a still image, an LV image can be generated even during exposure of a still image, and the frame rate of the LV display and the frame rate of continuous shooting of still images can be kept constant.

### Modification

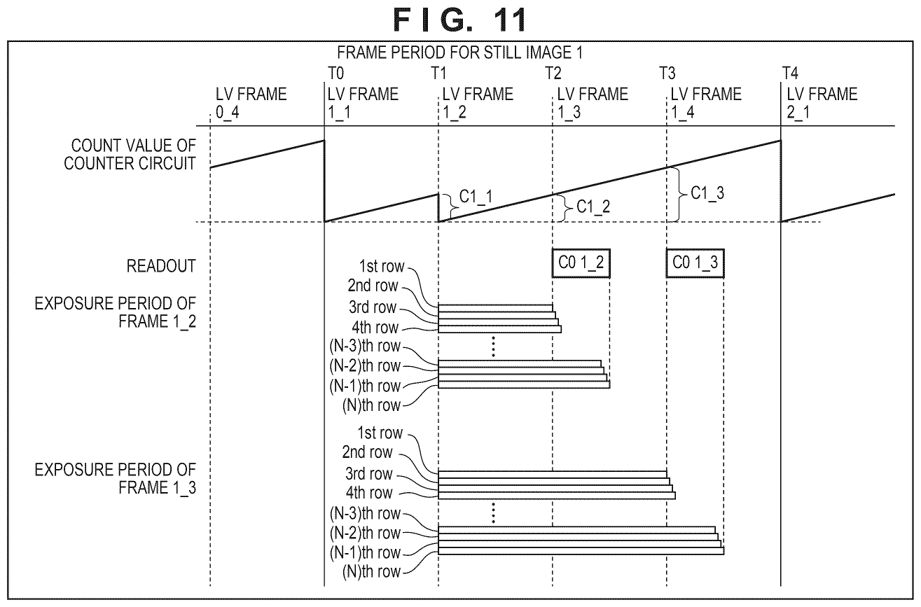

In the first embodiment described above, counting is started simultaneously for all pixels, and count values are read out row by row. FIG. 11 is a diagram showing the exposure period for each row of the frames 1_2 and 1_3 in FIG. 7. As shown in FIG. 11, exposure of all pixels is started by resetting count values at the start of the LV frame 1_2 (time T1), but reading of the LV frame 1_2 is performed row by row from time T2. This results in a difference in exposure period between the row read out first (1st row) and the row read out last (Nth row).

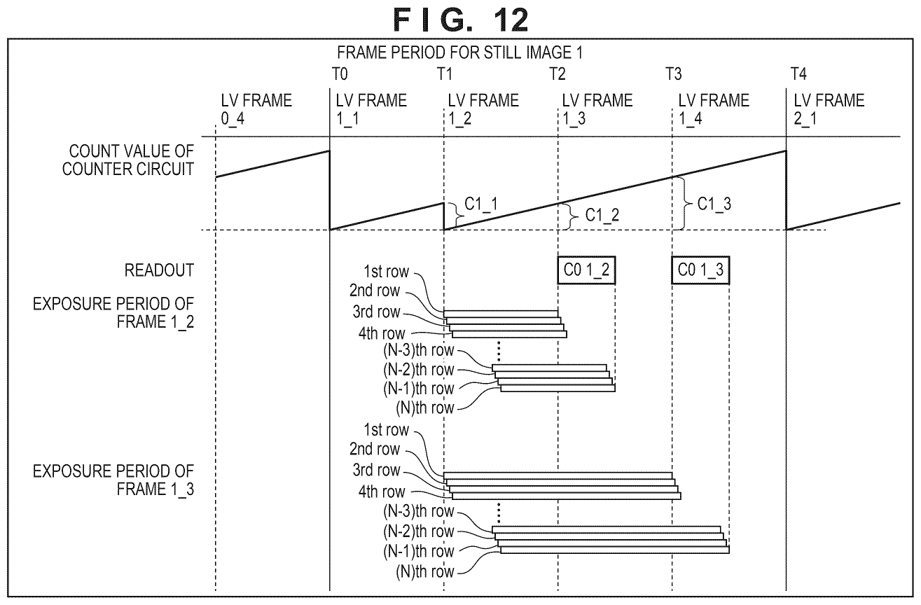

In order to solve the above problem, the timing at which counting starts may be shifted row by row depending on the readout timing. FIG. 12 is a diagram showing the exposure period for each row of the LV frame 1_2 and the LV frame 1_3. In this case, by shifting the timing at which the count values are reset to match the timing at which the count values of each row are read out, the exposure periods of the row read out first (1st row) and of the row read out last (Nth row) can be made the same.

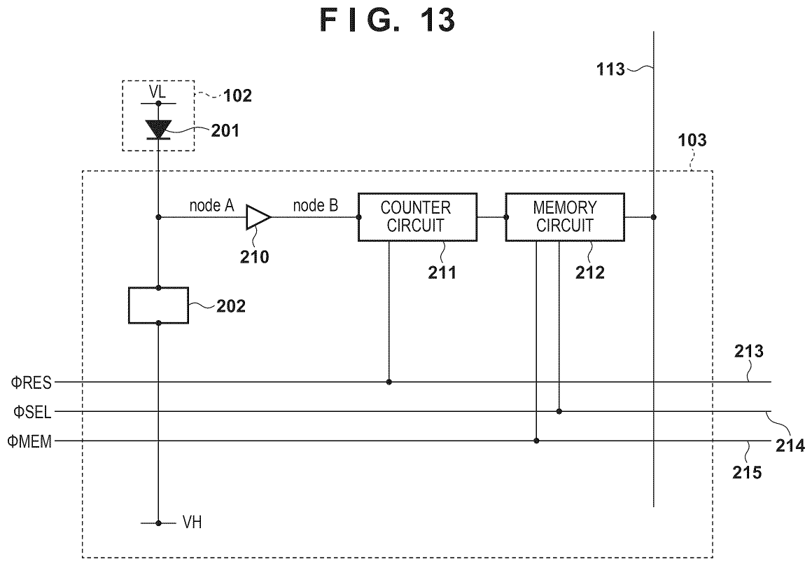

Moreover, the image sensor 100 shown in the first embodiment may be configured such that each signal processing circuit 103 has a memory. FIG. 13 is a block diagram showing the configuration of one photoelectric conversion unit 102 and one signal processing circuit 103 corresponding to the photoelectric conversion unit 102 in a case where a memory circuit 212 is added to the signal processing circuit 103. Note that the same reference numerals are assigned to the same components as those shown in FIG. 4.

As shown in FIG. 13, the memory circuit 212 is arranged after the counter circuit 211. A control pulse φRES is supplied to the counter circuit 211 via the actuation line 213, and a control pulse φSEL is supplied to the memory circuit 212 via an actuation line 214 and a control pulse φMEM is supplied to the memory circuit 212 via an actuation line 215. The counter circuit 211 resets its count value when the control pulse φRES is supplied and starts counting from that point. When the control pulse φMEM is supplied, the memory circuit 212 acquires and holds the count value at that time from the counter circuit 211. When the control pulse φSEL is then supplied, the memory circuit 212 outputs the held count value to the vertical signal line 113. This makes it possible to make the exposure timing of the row read out first (1st row) and the row read out last (Nth row) the same.

### Second Embodiment

The second embodiment will be described below. Note that the image sensor 100 and image capturing apparatus 600 described in the first embodiment or its modification can be used as the image sensor and image capturing apparatus in the second embodiment, and therefore a description thereof will be omitted here. In the second embodiment, the image sensor 100 is actuated by a control method different from that in the first embodiment, and therefore the control method of the image sensor 100 in the second embodiment will be described below.

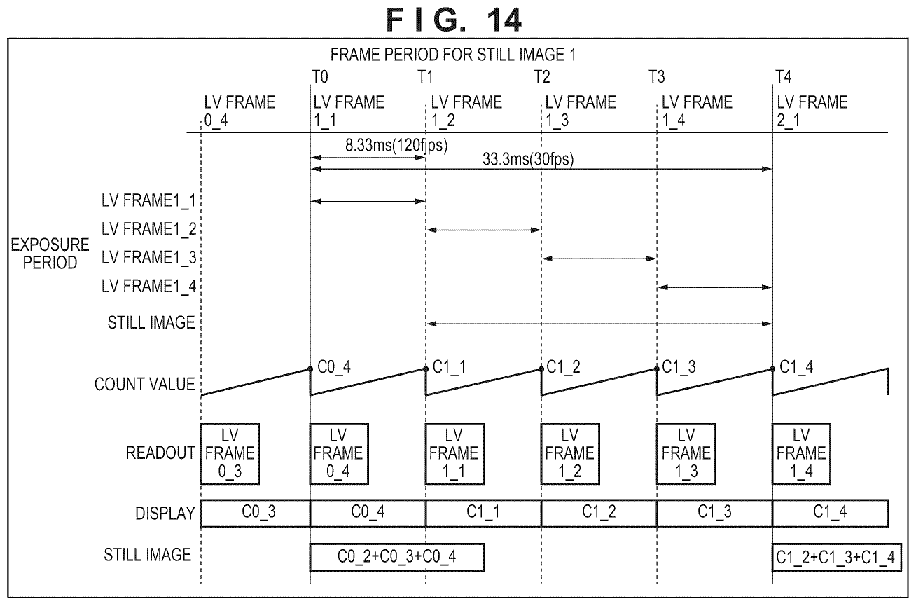

FIG. 14 is a timing diagram for explaining the control method of the image sensor 100 controlled by the overall control and calculation unit 603 according to the second embodiment. In the second embodiment, an operation in the case where the counter circuit 211 is reset at the readout timing of the LV frame is shown.

In this embodiment, as in the first embodiment, the control in a case where continuous shooting of still images at 30 fps is instructed by the operation unit 610 while an LV image is being captured at 120 fps will be described. Also in the second embodiment, the exposure period (counting period) of a still image is set to be an integer multiple of one frame period of the LV image, and the count start timing of the counter circuits 211 and the readout timing of the count values are controlled to match the frame rate of the LV image. Furthermore, in this embodiment, one still image will be shot with three frame periods of the LV image being set as the exposure period (25 ms) of the still image.

In the second embodiment, as shown in FIG. 14, in each LV frame, the counter circuits 211 are reset at the readout timing (time T0, T1, T2, T3, . . . ). Then, at times T1 to T4, count values C1_1, C1_2, C1_3, and C1_4 of LV frame 1_1, LV frame 1_2, LV frame 1_3, and LV frame 1_4, respectively, are read out from the counter circuits 211. Then, a still image is generated by adding up the count values C1_2, C1_3, and C1_4 corresponding to the exposure period (frames 1_2 to 1_4).

As described above, according to the second embodiment, by adding signals for an LV image to obtain a signal corresponding to the exposure period of a still image, it is possible to capture a still image expressed by count values beyond the counting ability of the counter circuits 211 without reducing the frame rate of the LV image.

In the first and second embodiments described above, the frame period of an LV image is set to ¼ of one frame period of a still image, and four frame images of the LV image is read out per each frame period of the still image, but the present disclosure is not limited to this. For example, when a still image shooting instruction is received from the operation unit 610, the frame rate of the LV image may be changed. Also, one frame period of an LV image may be set to, for example, ⅕ or ⅓ of one frame period of a still image depending on the recognition accuracy of the image signal processing circuit 602. Alternatively, the exposure period of the LV image may be changed depending on the brightness of a subject.

Further, display control may be performed so that the display frame rate of the display unit 608 is increased in accordance with the changed frame rate of the LV image, or consecutive frames of the LV image may be added together to maintain the display frame rate of the display unit 608. By increasing the frame rate of the LV image, it becomes possible to more precisely control the exposure period of the still image.

Furthermore, even if the exposure period of an LV image is set to ¼ of one frame period of a still image, the exposure periods of the LV frames 1_1, 1_2, 1_3, and 1_4 may be set shorter depending on the brightness of a subject, the image recognition accuracy, etc. In that case, in a frame such as the LV frame 1_1 whose exposure period does not overlap with an exposure period of a still image, the counter circuit can be reset at the timing of starting counting, thereby the effective exposure period can be set shorter than one frame period of the LV image. In addition, in a frame such as the LV frames 1_2, 1_3, and 1_4 whose exposure period does not overlap with an exposure period with a still image, a signal readout process is performed at the timing of starting exposure and by taking the difference between the readout signals, the effective exposure period can be set shorter than one frame period of the LV image.

In the above-mentioned first and second embodiments, the continuous shooting of still images are performed while capturing an LV image, but the present disclosure can also be applied to the case where the continuous shooting of still images are performed while capturing a moving image for recording.

### Modification

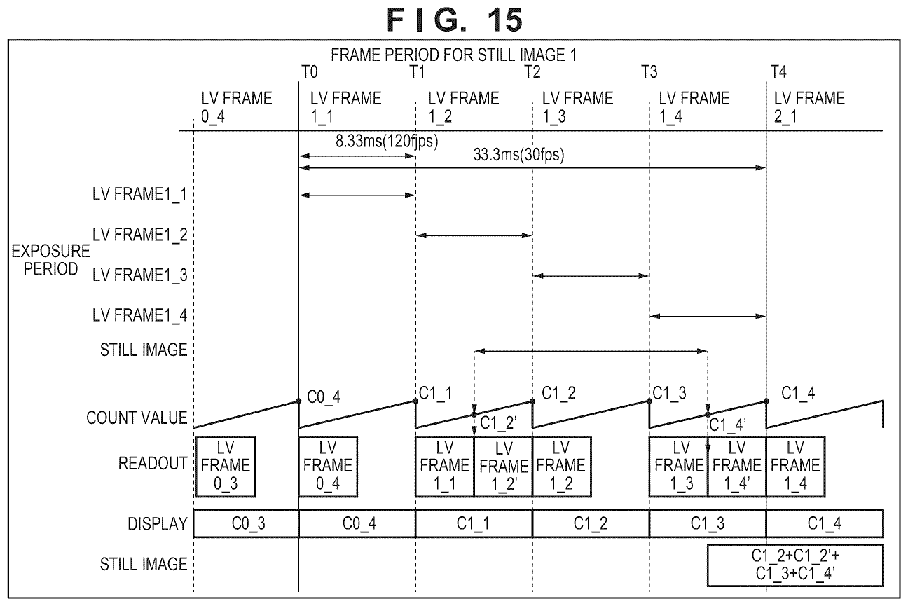

In the second embodiment, the exposure period of a still image is set to an integer multiple of one frame period of a moving image for display, but the present disclosure is not limited to this, depending on the brightness of the subject and the image recognition accuracy. For example, if a signal is read out middle of an LV frame, it is possible to obtain a still image with the desired exposure period by taking the difference between the signal and the the signal of the LV frame. The operation in this case is shown in FIG. 15.

FIG. 15 shows control in a case where the exposure period of a still image is set to be from the middle of the LV frame 1_2 to the middle of the LV frame 1_4. Here, a count value C1_2′ is read out at the timing when it is desired to start exposure for a still image, and a count value C1_4′ is read out at the timing when it is desired to end exposure. At this time, the signal of the still image can be obtained by adding the difference between C1_2 and C1_2′, C1_3, and C1_4′.

It should be noted that by introducing a similar concept into the first embodiment and subtracting the signal read out in the middle of the frame period of the LV image, the exposure period of the still image can be freely set even in the control of the first embodiment without being limited to an integer multiple of the frame period of the LV image.

### Other Embodiments

This disclosure may be applied to a system consisting of a plurality of devices, or to an apparatus consisting of a single device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to maintain the continuous shooting rate at the time of continuously shooting still images, while simultaneously acquiring a high frame rate moving image for recording or a moving image for display.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-147843, filed Aug. 29, 2024 which is hereby incorporated by reference herein in its entirety.

What is claimed is:

1. An image capturing apparatus comprising:
a plurality of pixels, each of which includes a sensor that outputs pulses at a frequency corresponding to a frequency of receiving a photon, and a counter that counts the number of the pulses; and
one or more processors and/or circuitry which function as:
a control unit that controls a timing for resetting count values counted by the counters and a timing for reading out the count values; and
a generation unit that generates a first signal at a predetermined first frame rate based on the count values read out at a plurality of different timings and the timings at which the count values are read out, and generates a second signal at a second frame rate corresponding to an exposure period longer than each frame period of the first frame rate,
wherein in a case of resetting the count values, the control unit performs control so as to read out the count values and then reset the count values.

2. The image capturing apparatus according to claim 1, wherein the control unit performs control so as to reset the count values at the start of each frame period in a case where the exposure period does not overlap with the frame period.

3. The image capturing apparatus according to claim 1, wherein
the exposure period is an integer multiple of each frame period, and
the control unit controls to reset the count values at the start of the exposure period.

4. The image capturing apparatus according to claim 3, wherein the control unit controls the count values to be read out at the end of the exposure period.

5. The image capturing apparatus according to claim 2, wherein
the control unit controls to read the count values from the counters at the start of the exposure period and at the end of the exposure period, and
the generation unit generates the second signal by subtracting the count values read at the start of the exposure period from the count values read at the end of the exposure period.

6. The image capturing apparatus according to claim 2, wherein
the control unit controls to read out the count values at the end of each frame period, and
the generation unit generates the first signal by subtracting the count values read out at the end of preceding one frame period from the count values read out at the end of each frame period in a case where the exposure period overlaps with each frame period.

7. The image capturing apparatus according to claim 1, wherein the control unit controls to reset the counters at the start of each frame period.

8. The image capturing apparatus according to claim 7, wherein
the exposure period is an integer multiple of each frame period,
the control unit controls to read out the count values at the end of each frame period, and
the generation unit generates the second signal by adding up the count values read out at the end of the frame periods corresponding to the exposure period.

9. The image capturing apparatus according to claim 7, wherein
the control unit controls to read out the count values from the counters at the start and end of the exposure period, and
the generation unit generates the second signal by subtracting the count values read out at the start of the exposure period from the sum of the count values read out at the end of each frame period included between the start of the exposure period and the end of the exposure period and the count values read out at the end of the exposure period.

10. The image capturing apparatus according to claim 1, wherein the one or more processors and/or circuitry further function as a setting unit that sets an exposure period of the first signal, and
the control unit controls to read out the count values at the start and end of the exposure period of the first signal in each frame period in a case where the exposure period of the first signal is shorter than each frame period, and
the generation unit generates the first signal by subtracting the count values read out at the start of the exposure period of the first signal from the count values read out at the end of the exposure period of the first signal.

11. The image capturing apparatus according to claim 10, wherein the start of the exposure period of the first signal is the start of each of the frame periods, or the end of the exposure period of the first signal is the end of each of the frame periods.

12. The image capturing apparatus according to claim 1, wherein the one or more processors and/or circuitry further function as an image processing unit that performs image processing so that luminance between frames of the first signal generated by the generation unit becomes constant.

13. The image capturing apparatus according to claim 4, wherein at the time of reading out the count values except at the end of the exposure period, pixels are thinned out from among the plurality of pixels at a predetermined rate and the count values are read out.

14. The image capturing apparatus according to claim 1, wherein the one or more processors and/or circuitry further function as a display control unit that controls the first signal to be displayed on a display device at the first frame rate.

15. The image capturing apparatus according to claim 1, wherein
the plurality of pixels are arranged two-dimensionally in a plurality of rows and a plurality of columns, and
the control unit shifts the timing of the reset and the timing of the readout row by row so that the periods from resetting the counters to reading the count values are constant in the all rows.

16. The image capturing apparatus according to claim 1, wherein
each pixel further includes a memory that stores the count value counted by the counter, and
the control unit resets the plurality of pixels at the same timing and stores the count values in the memories at the same timing for the plurality of pixels.

17. The image capturing apparatus according to claim 1 further comprising a readout unit that reads out the count values, and
the operation of the readout unit is stopped while the count values are not being read out.

18. The image capturing apparatus according to claim 1 further comprising an operation unit that is used to set the exposure period and the second frame rate,
wherein the one or more processors and/or circuitry further function as a setting unit that sets the first frame rate to be an integer multiple of the second frame rate.

19. The image capturing apparatus according to claim 1, wherein the first signal is a signal of a moving image to be displayed or a moving image to be recorded, and the second signal is a signal of a still image.

20. A non-transitory computer-readable storage medium, the storage medium storing a program that is executable by the computer, wherein the program includes program code for causing the computer to function as a control unit and a generation unit of an image capturing apparatus, comprising:
a plurality of pixels, each of which includes a sensor that outputs pulses at a frequency corresponding to a frequency of receiving a photon, and a counter that counts the number of the pulses; and
a control unit that controls a timing for resetting count values counted by the counters and a timing for reading out the count values; and
a generation unit that generates a first signal at a predetermined first frame rate based on the count values read out at a plurality of different timings and the timings at which the count values are read out, and generates a second signal at a second frame rate corresponding to an exposure period longer than each frame period of the first frame rate,
wherein in a case of resetting the count values, the control unit performs control so as to read out the count values and then reset the count values.
